(19) United States
(12) Patent Application Publication
(10) Pub. No.: US 2002/0139619 A1
(43) Pub. Date: Oct. 3, 2002

(54) Hoistwayless elevator system

(76) Inventors: Minglun Qiu, Bloomington, IN (US); Leandre Adifon, Farmington, CT (US)

Correspondence Address: OTIS ELEVATOR COMPANY, INTELLECTUAL PROPERTY DEPARTMENT, 10 FARM SPRINGS, FARMINGTON, CT, 06032, US

(21) Appl. No.: 09/571,896

(22) Filed: May 16, 2000

(51) Int. Cl. B66B 9/16

(52) U.S. Cl. 187/239

(57) ABSTRACT

An elevator system includes an elevator car and a counterweight installed in parallel with an outer wall of a building. The system is mounted to a single wall and can be installed into preexisting, multi-floor structures which have been constructed without an elevator hoistway. To move the car between floors, a drive assembly is mounted to a structural beam attached to the outer wall. The structural beam extends from the outer wall and is at least partially supported by the elevator car guide rails. Since no interior building space or hoistway is required, the system can be manufactured as a pre-assembled unit and attached to a new or existing structure

### BACKGROUND OF THE INVENTION

This invention relates to an elevator system, and more particularly to an elevator system designed for installation adjacent an external wall of a preexisting structure.

Typical elevator systems require a dedicated shaft or hoistway and are installed during the construction of a building. The hoistway typically makes use of a plurality of support walls in the structure. In one known elevator system a first elevator car guide rail is attached to a first wall in the hoistway while a second car guide rail is attached to a wall opposite the first wall. Counterweight guide rails are attached to a third wall of the hoistway while door openings are provided in a wall opposite the third wall. Thus, in a typical elevator system installation, all four walls of the hoistway are used by the elevator system.

Many preexisting multi-floor structures have been constructed without an elevator system. It is therefore desirable to provide an elevator system that can be retrofitted to preexisting structures.

### SUMMARY OF THE INVENTION

The elevator system according to the present invention includes an elevator car and a counterweight mounted in parallel in relation to a single building wall. The inventive elevator system preferably is mounted to an outer wall of a building. The system can be installed into preexisting, multi-floor structures which have been constructed without an elevator hoistway.

To move the car between floors, a drive assembly is mounted to a structural beam attached to the outer wall. The structural beam is attached to first and second car and counterweight guide rails, which are attached to the beam and mounted to the outer wall and the ground. The structural beam extends from the outer wall and is at least partially supported by the car and counterweight guide rails to form a rigid, box-like structure to support the elevator system.

The drive assembly preferably includes an integrated gearless drive machine and controller that drives a rope attached to the car frame and counterweight. The elevator cab is mounted on the car frame and is movable along the guide rails on roller assemblies. Correspondingly, the counterweight is movable along the counterweight guide rails to balance the cab.

In one example of this invention the elevator car and counter weight are attached to the drive assembly by a core steel belt (CSB) which travels along car roller assemblies mounted to the car frame and counterweight roller assemblies mounted to the counter weight.

The various features and advantages of this invention will become apparent to those skilled in the art from the following detailed description of the currently preferred embodiment. The drawings that accompany the detailed description can be briefly described as follows.

### BRIEF DESCRIPTION OF THE DRAWINGS

FIG. 1 is a general perspective view of an hoistwayless elevator system mounted to an external wall of a building.

FIG. 2 is a side view the elevator system of FIG. 1.

FIG. 3 is a front view the elevator system of FIG. 1.

### DETAILED DESCRIPTION OF THE PREFERRED EMBODIMENT

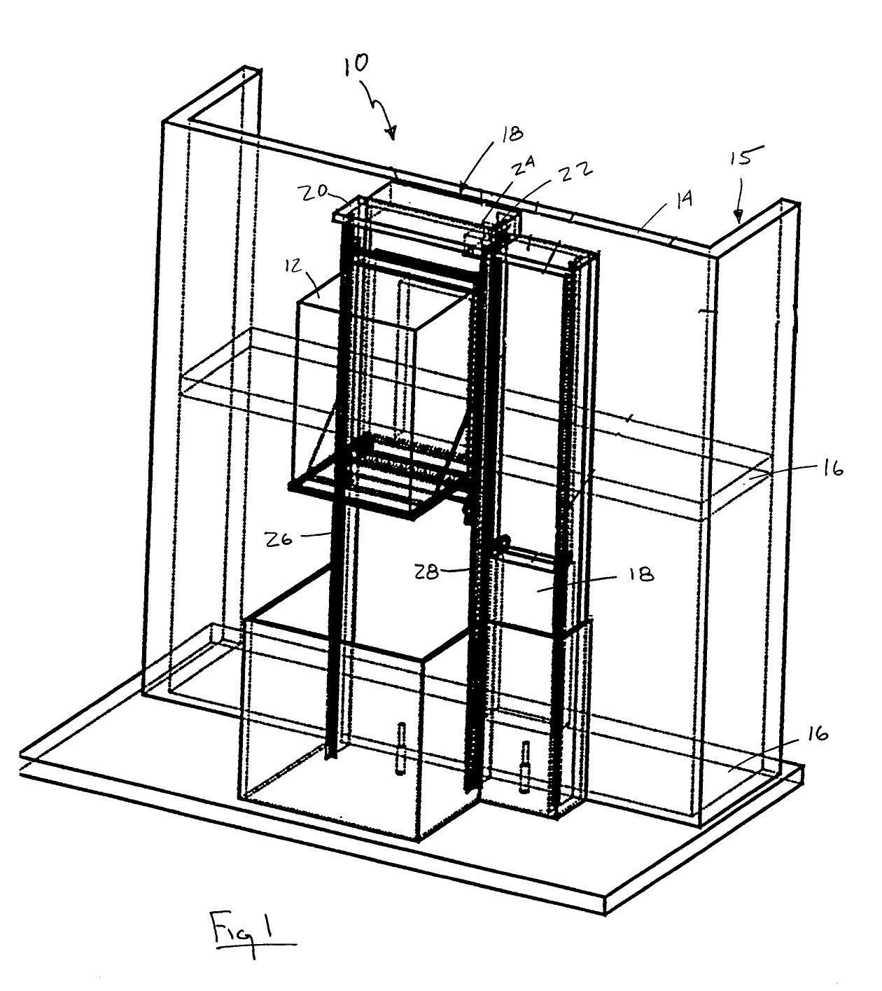

FIG. 1 illustrates a hoistwayless elevator system 10. The system 10 generally includes a car 12 installed adjacent an outer wall 14 of a building 15 for movement between floors 16. A counterweight 18 is installed in parallel with the car 12 in relation to the outer wall 14 to balance the car 12 in a known manner. Operation of an elevator car with a counterweight is known and will not be discussed here in detail.

As illustrated in FIG. 1, the system 10 is mounted to an outer wall 14 of the building 15 which allows the system 10 according to the present invention to be installed into preexisting multi-floor structures which have been constructed without an elevator hoistway. Although an outer or exterior wall is discussed in this specification, those skilled in the art will appreciate that this invention has usefulness in other situations. Therefore, a single-wall mounting is not necessarily limited to an exterior wall of a building. Some structures will accommodate the inventive system within a building.

To move the car 12 between floors 16, a drive assembly 18 is mounted to a structural beam 20 attached to the outer wall 14. The drive assembly 18 preferably includes an integrated gearless drive machine 22 and a controller 24. It is to be understood that the term drive assembly as used herein is not intended to be construed narrowly and should be taken to include elevator controllers, elevator drive machines, drive systems, governors, and other components commonly located in an elevator machine room to drive the elevator car between floors.

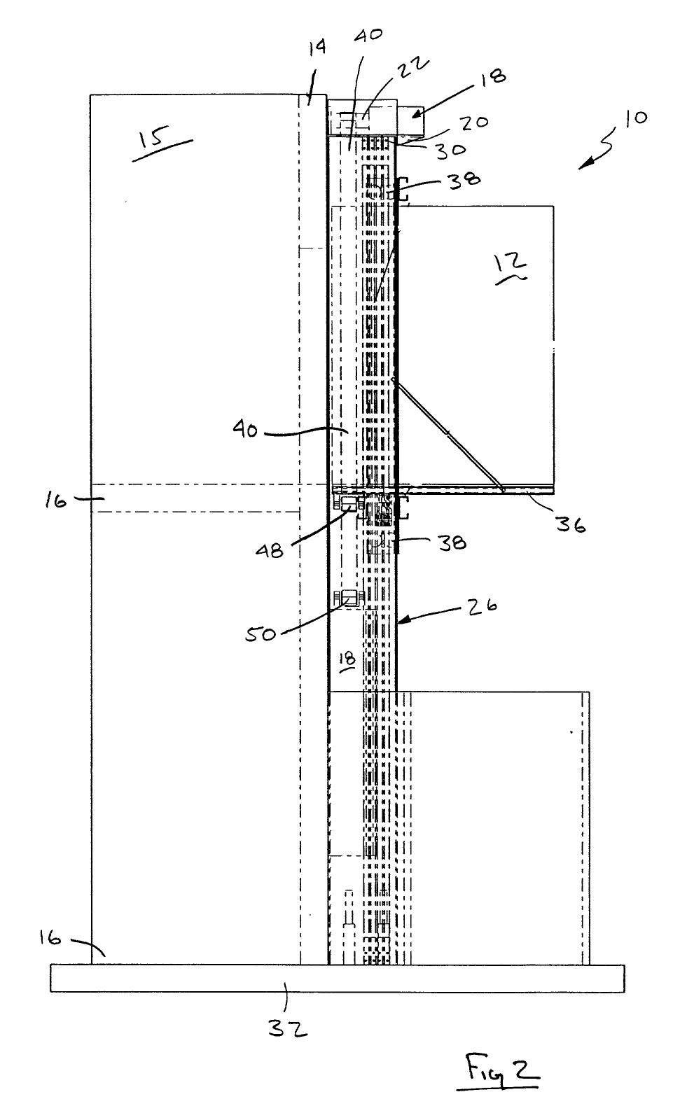

The structural beam 20 is preferably at least partially supported by a first car guide rail 26 and a second car guide rail 28 which are mounted to the outer wall 14. Referring to FIG. 2, the structural beam 20 extends from the outer wall 14 and is supported by the car guide rails 26, 28. The second car guide rail 28 is obscured in FIG. 2 by the first car guide rail 26. The car guide rails 26, 28 preferably are further affixed to the ground 32 and attached to the outer wall 14. The car guide rails 26, 28 are attached to the beam 20 by fasteners 30 such as bolts. Other direct attachment configurations are contemplated within the present invention, such as welded connections, for example.

The elevator car 12 preferably is mounted on a cantilever car frame 36, which is movable along the car guide rails 26, 28 on roller assemblies 38 or the like. The drive assembly 18 drives a rope 40 which is attached to the car frame 36 and counterweight 18. Preferably, the rope 40 is a core steel belt (CSB) which travels along a car roller assembly 48 mounted to the car frame 36 and counterweight roller assemblies 50 mounted to the counterweight 18.

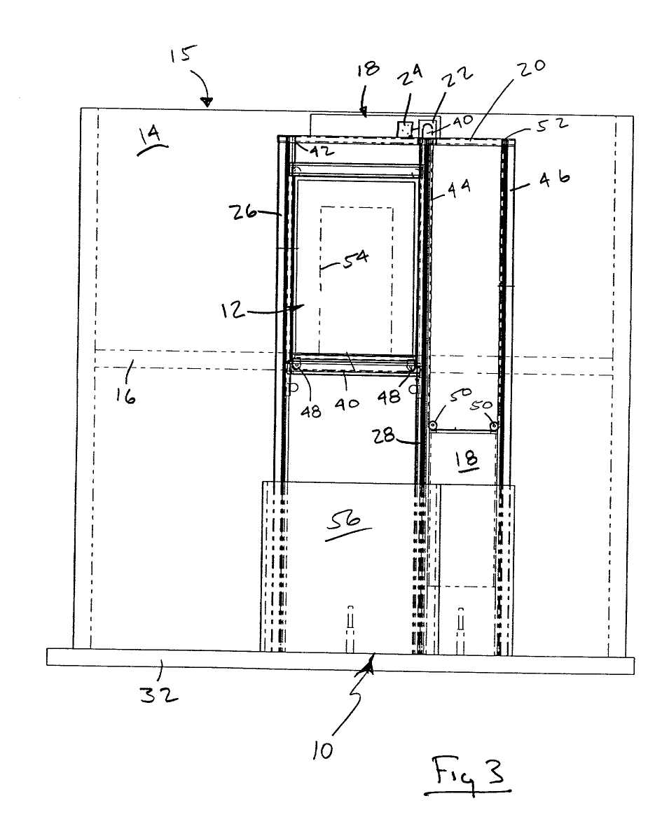

Referring to FIG. 3, the structural beam 20 is preferably additionally supported by a first counterweight guide rail 44 and a second counterweight guide rail 46, which are attached to the beam 20. The counterweight guide rails 44, 46 also preferably are mounted to the outer wall 14 and ground 32. A rigid box-like structure to support the system 10 is thereby formed between the beam 20, car guide rails 26, 28, counterweight guide rails 44, 46 and the ground 32.

The rope 40 is attached at a first end 42 to the structural beam 20. From the first end 42, the rope travels along the first car guide rail 26, through the car roller assemblies 48 attached below the cantilever car frame 36 and up into the drive assembly 18 along the second car guide rail 28. From the drive assembly 18 the rope 40 travels along the first counterweight guide rail 44, through counterweight roller assemblies 50 attached to the counterweight 18. From the counterweight roller assemblies 50 the rope 40 is guided along the second counterweight guide rail 46 where an opposite end 52 of the rope 40 is attached to the structural beam 20. Although a 2:1 underslung car and overslung counterweight roping is illustrated, other roping paths and car and counterweight attachments can be used as part of the present invention.

Notably, the counterweight 18 and the car 12 are installed in parallel relative to the outer wall 14. Since no interior building space or hoistway is required, the system 10 can be manufactured as a pre-assembled unit and attached to a new or existing structure.

To install the system 10 to a preexisting structure, landings 54 are installed through the outer wall 14 at appropriate locations on each floor 16. The system 10 then is installed. Finally, an outer covering 56 is affixed to the building 15 to protect and conceal the system 10.

The foregoing description is exemplary rather than defined by the limitations within. Many modifications and variations of the present invention are possible in light of the above teachings. The preferred embodiments of this invention have been disclosed, however, one of ordinary skill in the art would recognize that certain modifications would come within the scope of this invention. It is, therefore, to be understood that within the scope of the appended claims, the invention may be practiced otherwise than as specifically described. For that reason the following claims should be studied to determine the true scope and content of this invention.

What is claimed is:

1. An elevator system comprising:
an elevator car movably mounted adjacent a single wall; and
a counterweight movably mounted adjacent the single wall, said elevator car and said counterweight oriented in parallel with respect to the single wall.

2. The system of claim 1, including an elevator car guide rail supported by the single wall and a counterweight guide rail supported by the single wall.

3. The elevator system as recited in claim 2, including a drive assembly mounted to a structural beam attached to the outer wall, said drive assembly attached to said elevator car and said counterweight.

4. The elevator system as recited in claim 3, wherein said drive assembly is attached to said elevator car and said counterweight through a core steel belt.

5. The elevator system as recited in claim 3, wherein said structural beam is at least partially supported by the elevator car guide rail.

6. The elevator system as recited in claim 3, wherein said structural beam is at least partially supported by the counterweight guide rail.

7. An elevator system comprising:
a beam attached to one wall of a building;
a drive assembly mounted to said beam;
an elevator car guide rail supported by the one wall and at least partially supporting said beam;
an elevator car mounted adjacent the one outer wall and movable along said elevator car guide rail in response to said drive assembly; and
a counterweight mounted adjacent the one wall and movable in response to said drive assembly.

8. The elevator system as recited in claim 7, including a core steel belt drivable by said drive assembly and attached to said elevator car and said counterweight through a plurality of rollers.

9. The elevator system as recited in claim 7, including an outer covering for said elevator system.

10. The elevator system as recited in claim 7, wherein said elevator system is a pre-assembled unit.
